(19) United States
(12) Patent Application Publication
(10) Pub. No.: US 2025/0228375 A1
(43) Pub. Date: Jul. 17, 2025

(54) Inflatable Structure, Inflatable Product, and Method for Manufacturing Inflatable Product

(71) Applicants: ZHEJIANG NATURAL OUTDOOR GOODS INC., Taizhou (CN); EQUIP OUTDOOR TECHNOLOGIES UK LTD, Alfreton (GB)

(72) Inventors: Yonghui XIA, Taizhou (CN); Junwei YAO, Taizhou (CN); Jing GUO, Taizhou (CN); Tim FISH, Alfreton (GB); Benjamin MANWARING, Alfreton (GB)

(73) Assignees: ZHEJIANG NATURAL OUTDOOR GOODS INC., Taizhou (CN); EQUIP OUTDOOR TECHNOLOGIES UK LTD, Alfreton (GB)

(21) Appl. No.: 18/856,628

(22) PCT Filed: Jun. 14, 2023
(86) PCT No.: PCT/CN2023/100281

§ 371 Date: Oct. 14, 2024

(30) Foreign Application Priority Data
Apr. 14, 2022 (CN) 202210392078.7

(51) Int. Cl. A47C 27/10; A47C 27/12

(52) U.S. Cl. CPC A47C 27/10; A47C 27/122

(57) ABSTRACT

Provided are an inflatable structure, an inflatable product, and a method for manufacturing for an inflatable product. The inflatable structure comprises a first layer and a second layer; a composite material comprises a plurality of filling materials which are sequentially stacked from top to bottom; a reflective layer is arranged between a pair of adjacent filling materials; an upper end of the composite material is connected to the first layer, and a lower end of the composite material is connected to the second layer. The composite material is arranged between the first layer and the second layer of the inflatable structure, and said composite material is respectively stretched by the first layer and the second layer; the stretched filling materials are attached to upper and lower surfaces of the reflective layer like two spring structures; when external vibrations are transmitted to the reflective layer, said vibrations are dampened.

### CROSS-REFERENCE TO RELATED APPLICATIONS

The present disclosure claims the priority to the Chinese patent application with the filling No. 202210392078.7 filed with the Chinese Patent Office on Apr. 14, 2022, and entitled “Inflatable Structure, Inflatable Product, and Method for Manufacturing Inflatable Product”, the contents of which are incorporated herein by reference in entirety.

### TECHNICAL FIELD

The present disclosure relates to the technical field of inflatable products, and in particular to an inflatable structure, an inflatable product, and a method for manufacturing inflatable product.

### BACKGROUND ART

On the market, inflatable products, in order to enhance the thermal insulance (unit under the international standard is (m²K)/W) of the air cushion, usually add hollow fiber cotton inside the air cushion to reduce the heat convection inside the air cushion.

Hollow fiber cotton is a type of high-insulation cotton product, with polyester filaments as the raw material. Coarse hollow fibers are used as the main body, and fine hollow fibers are intertwined around the coarse backbone, thus forming a feather-like branching structure. In the expanded state, it can form numerous gas chambers with a volume smaller than that of water molecules. These gas chambers can retain the heat emitted by the body. However, during the manufacturing and usage of inflatable cushions, hollow fiber cotton is in a compressed or incompletely expanded state, thus preventing the material from fully utilizing its superior insulation performance.

Moreover, by arranging a reflective layer inside the inflatable product, when pressure is applied to the reflective layer during use, a slight contortion of the reflective layer can produce greater noise, thus affecting the user experience of those with lighter sleep.

### SUMMARY

The objective of the present disclosure is to provide an inflatable structure, an inflatable product, and a method for manufacturing an inflatable product to address technical issues where the insulation performance of inflatable products cannot be fully utilized, and noise is easily generated from the reflective layer arranged inside inflatable products, thereby affecting the sleep quality of the user.

In the first aspect, the present disclosure provides an inflatable structure comprising a first layer and a second layer. A plurality of baffles are arranged between the first layer and the second layer, and a first tubular cavity is formed between the first layer and the second layer by the two adjacent baffles. A composite material is arranged within the first tubular cavity.

The composite material comprises a plurality of filling materials which are sequentially stacked from top to bottom, and a reflective layer is arranged between the two adjacent filling materials. An upper end of the composite material is connected to the first layer, and a lower end of the composite material is connected to the second layer.

In optional embodiments, a material of the first layer, the second layer, and the baffle includes one of textile with PVC coating, textile with TPU coating, PVC film, and TPU film.

In optional embodiments, the filling material is a hollow fiber cotton.

In optional embodiments, the reflective layer is a PET film coated with aluminum or aluminum foil. The filling material is adhered to the reflective layer.

In optional embodiments, an edge of the first layer is connected to an edge of the second layer. A connecting cavity in communication with the first tubular cavity is formed on both ends in a length direction of the first tubular cavity. A second tubular cavity is formed on both sides in the length direction of the first tubular cavity.

In optional embodiments, the second tubular cavity is provided therein with a composite material.

The composite material is arranged between the first layer and the second layer of the inflatable structure of the present disclosure, and the composite material is respectively stretched by the first layer and the second layer. The stretched filling materials are attached to the upper and lower surfaces of the reflective layer like two spring structures. When external vibrations are transmitted to the reflective layer, the vibrations are dampened, and therefore the reflective layer can be stably and constantly located at a central position between the first layer and the second layer, and noise will not be made due to contortion.

Similarly, because the composite material is connected respectively to both the first layer and the second layer, so that the composite material is in a stretched state, and the volume percentage occupied by the filling material in the first tubular cavity increases, thus allowing excellent performance of the filling material to be fully utilized.

In the second aspect, the present disclosure provides an inflatable product, comprising any of the inflatable structures described in the previous embodiments.

In optional embodiments, an air nozzle is further included, wherein the air nozzle is arranged on the first layer or the second layer, and the air nozzle is communicated with the connecting cavity.

The present disclosure also provides an inflatable product, wherein the inflatable product adopts the aforementioned inflatable structure, thereby possessing all the beneficial effects of the inflatable structure.

In the third aspect, the present disclosure provides a method for manufacturing the inflatable product, including the following steps:
S1: welding the upper and lower ends of a plurality of the baffles onto the first layer and the second layer separately, so that a plurality of first tubular cavities are formed;
S2: inserting the composite material into the first tubular cavity and ensuring that the reflective layer is horizontal;
S3: melting a coating on an inner wall of the first tubular cavity by applying heat externally to the first layer, and welding the upper end of the composite material to the first layer; melting the coating on the inner wall of the first tubular cavity by applying heat externally to the second layer, and welding the lower end of the composite material to the second layer; and
S4: welding an edge of the first layer and an edge of the second layer together.

In optional embodiments, before step S1, it also includes step S0: adhering the filling material to the reflective layer to form the composite material.

### BRIEF DESCRIPTION OF DRAWINGS

In order to more clearly illustrate the specific embodiments of the present disclosure or the technical solutions in the prior art, the drawings required to be used in the description of the specific embodiment or prior art will be briefly introduced as follows. Obviously, the drawings described below are some embodiments of the present disclosure, for those of ordinary skill in the art, without paying inventive efforts, can also obtain other drawings according to these drawings.

FIG. 1 is a schematic diagram of a structure of an inflatable structure provided in the embodiments of the present disclosure;

FIG. 2 is a schematic diagram of the structure of the other angle of an inflatable structure shown in FIG. 1;

FIG. 3 is a schematic diagram of a structure of an inflatable product provided in the embodiments of the present disclosure;

FIG. 4 is a schematic diagram of an internal structure of a part of the inflatable product shown in FIG. 3; and

FIG. 5 is a flowchart of a method for manufacturing the inflatable product provided in the embodiments of the present disclosure.

Reference numerals: 100—first layer; 200—second layer; 300—composite material; 301—filling material; 302—reflective layer; 400—first tubular cavity; 500—second tubular cavity; 600—baffle; 700—air nozzle; 800—connecting cavity.

### DETAILED DESCRIPTION OF EMBODIMENTS

A clear and complete description of the technical solutions of the present disclosure will be given below in connection with embodiments. It is clear that the embodiments described are a part and not all of the embodiments of the present disclosure. Based on the embodiments in the present disclosure, all other embodiments obtained by those of ordinary skill in the art without making inventive efforts are within the scope of protection of the present disclosure.

### Embodiment

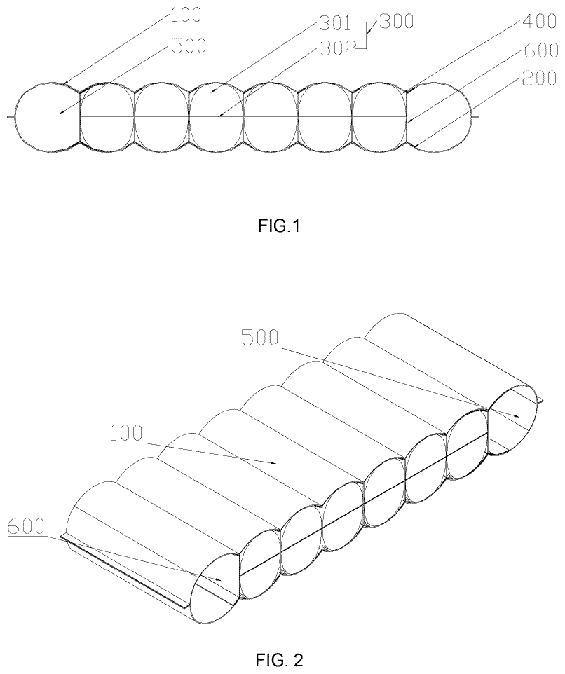

Referring to FIG. 1-FIG. 2, the present disclosure provides an inflatable structure comprising a first layer 100 and a second layer 200. A plurality of baffles 600 are arranged between the first layer 100 and the second layer 200, and a first tubular cavity 400 is formed between the first layer 100 and the second layer 200 by two adjacent baffles 600. A composite material 300 is arranged within the first tubular cavity 400.

The composite material 300 comprises a plurality of filling materials 301 which are sequentially stacked from top to bottom, and a reflective layer 302 is arranged between the two adjacent filling materials 301. An upper end of the composite material 300 is connected to the first layer 100, and a lower end of the composite material 300 is connected to the second layer 200.

In some embodiments, a plurality of baffles 600 are arranged between the first layer 100 and the second layer 200. The plurality of baffles 600 are connected to the first layer 100 at one end and to the second layer 200 at the other end. The first tubular cavity 400 is formed between the first layer 100 and the second layer 200 by the two adjacent baffles 600. Generally, a length direction of the first tubular cavity 400 is a length direction of the inflatable structure, and the length direction of the first tubular cavity 400 can also be a width direction of the inflatable structure.

The composite material 300 can be inserted into the first tubular cavity 400. The composite material 300 generally includes at least two filling materials 301 and a reflective layer 302. A filling material 301 is arranged at the upper and lower ends of the reflective layer 302, and the composite material 300 is connected to the first layer 100 and the second layer 200 through the filling material 301, respectively. When the inflatable structure is in the inflated state, the distance between the first layer 100 and the second layer 200 is larger, and the first layer 100 and the second layer 200 are stretched at both ends of the composite material 300, respectively, so that the filling material 301 is in a stretched state. The stretched filling materials 301 are attached to the upper and lower surfaces of the reflective layer 302 like two spring structures. When external vibrations are transmitted to the reflective layer 302, the vibrations are dampened, and therefore the reflective layer can be stably and constantly located at a central position between the first layer 100 and the second layer 200, and noise will not be made due to a contortion. The filling material 301 on both sides of the reflective layer 302 of the composite material 300 is generally symmetrically arranged, so that the reflective layer 302 is centrally located and generally horizontal.

Similarly, the filling material 301 is connected to both the first layer 100 and the second layer 200, so that the composite material 301 is in the stretched state, and the volume percentage occupied by the filling material 301 in the first tubular cavity 400 increases, and therefore the excellent performance of the filling material 301 can be fully utilized.

The filling material 301 can be connected to the reflective layer 302 through a vinyl acetate-ethylene copolymer emulsion.

Referring to FIG. 1, the first layer 100 is above the second layer 200 and the reflective layer 302 is horizontal.

In optional embodiments, the material of the first layer 100, the second layer 200, and the baffle 600 include one of textile with PVC coating, textile with TPU coating, PVC film, and TPU film.

In optional embodiments, the filling material 301 is a hollow fiber cotton.

In optional embodiments, the reflective layer 302 is a PET film coated with aluminum or aluminum foil. The filling material 301 is adhered to the reflective layer 302.

The filling material 301 is generally the hollow fiber cotton. The first layer 100 and the second layer 200 are made of the textiles with PVC coatings. The reflective layer 302 is made of the PET film coated with aluminum. The PET film coated with aluminum has good properties for reducing heat radiation from the human body and has a very low gram weight per square meter. The baffle 600 is made of the textile with PVC coating. When the baffle 600 needs to be connected to the first layer 100 and the second layer 200, the PVC coating on the baffle plate 600 is thermally fused by heating, thereby achieving the welding of the baffle 600 to the first layer 100 and the second layer 200. The first layer 100, the second layer 200, and the baffle 600 are generally made of the same material. The connection of the baffle 600 to the first layer 100 and the second layer 200 can also be achieved by a chemical reaction.

In optional embodiments, an edge of the first layer 100 is connected to an edge of the second layer 200. A connecting cavity 800 in communication with the first tubular cavity 400 is formed on both ends in the length direction of the first tubular cavity 400. A second tubular cavity 500 is formed on both sides in the length direction of the first tubular cavity 400.

To enable the inflatable structure to inflate and deflate the plurality of first tubular cavities 400 and the plurality of second tubular cavities 500 simultaneously with only one air nozzle 700, the connecting cavities 800 are formed at both ends of the inflatable structure in the length direction of the first tubular cavities 400. At least a connecting cavity 800 is arranged on one end of the inflatable structure in the length direction. The air nozzle 700 is arranged on the first layer 100 or the second layer 200, and the airflow entering through the air nozzle 700 can enter the connecting cavity 800, and hence the airflow passes through the connecting cavity 800 and enters into the first tubular cavity 400 and the second tubular cavity 500. A connecting cavity 800 is generally arranged at both ends of the inflatable structure in the length direction for the airflow circulation speed. When the composite material 300 is not inserted into the second tubular cavity 500, that is, after the airflow enters the connecting cavity 800 from the air nozzle 700, the airflow flows to both ends of the first tubular cavity 400 through the second tubular cavity 500 along the connecting cavity 800, thereby improving the speed of inflating the inflatable structure by the airflow.

The composite material 300 is arranged between the first layer 100 and the second layer 200 of the inflatable structure of the present disclosure, and the composite material 300 is respectively stretched by the first layer 100 and the second layer 200. The stretched filling materials 301 are attached to the upper and lower surfaces of the reflective layer 302 like two spring structures. When external vibrations are transmitted to the reflective layer 302, the vibrations are dampened, and therefore the reflective layer 302 can be stably and constantly located at a central position between the first layer 100 and the second layer 200, and noise will not be made due to contortion.

Similarly, because the composite material 300 is connected respectively to both the first layer 100 and the second layer 200, so that the composite material 300 is in the stretched state, and the volume percentage occupied by the filling material 301 in the first tubular cavity 400 increases, thus allowing the excellent performance of the thermal insulating of the filling material 301 to be fully utilized.

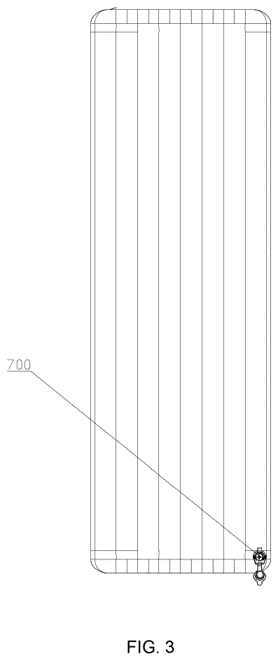

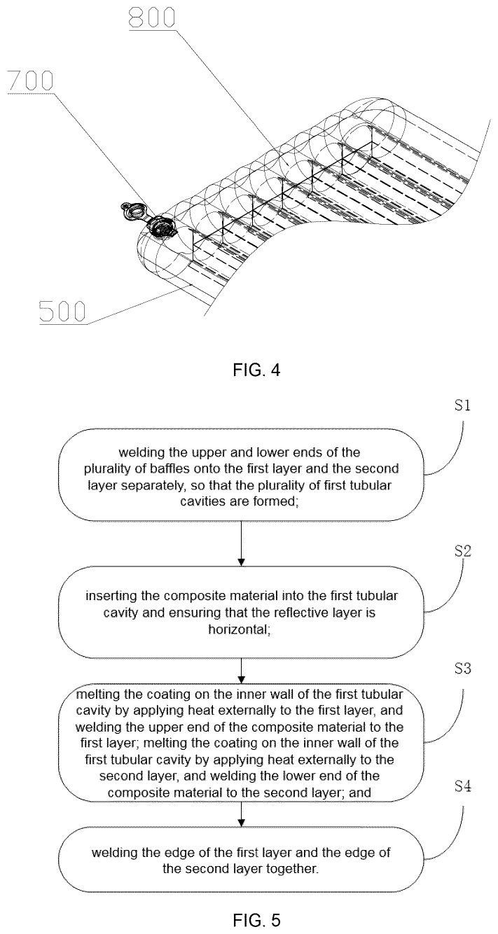

Referring to FIG. 3-FIG. 4, the present disclosure further provides an inflatable product, comprising any of the inflatable structures described in the previous embodiments.

In optional embodiments, the air nozzle 700 is further included, wherein the air nozzle 700 is arranged on the first layer 100 or the second layer 200, and the air nozzle 700 is communicated with the connecting cavity 800.

The present disclosure also provides an inflatable product, wherein the inflatable product adopts the aforementioned inflatable structure, thereby possessing all the beneficial effects of the inflatable structure.

Referring to FIG. 5, the present disclosure provides a method for manufacturing the inflatable product, including the following steps:
S1: welding the upper and lower ends of the plurality of baffles 600 onto the first layer 100 and the second layer 200 separately, so that the plurality of first tubular cavities 400 are formed;
S2: inserting the composite material 300 into the first tubular cavity 400 and ensuring that the reflective layer 302 is horizontal;
S3: melting a coating on an inner wall of the first tubular cavity 400 by applying heat externally to the first layer 100, so that the upper end of the composite material 300 is welded to the first layer 100; melting the coating on the inner wall of the first tubular cavity 400 by applying heat externally to the second layer 200, so that the lower end of the composite material 300 is welded to the second layer 200; and
S4: welding the edge of the first layer 100 and the edge of the second layer 200 together.

In optional embodiments, before step S1, it also includes step S0: adhering the filling material 301 to the reflective layer 302 to form the composite material 300.

The composite material 300 can include one reflective layer 302, two reflective layers 302, or a plurality of the reflective layers 302. The reflective layer 302 is arranged between two adjacent filling materials 301. The composite material 300 allows for mass production during the manufacturing process.

The manufacturing method of the inflatable product comprises first combining the filling material 301 and the reflective layer 302, and then combining the composite material 300 with the first layer 100 and the second layer 200. Therefore, a simple and mass production process is achieved.

Finally, it should be noted that the above embodiments are only used to illustrate the technical solutions of the present disclosure and are not intended to be a limitation thereof. Although the present disclosure is described in detail with reference to each of the foregoing embodiments, it should be understood by those of ordinary skill in the art that one can still modify the technical solutions described in the foregoing embodiments, or make equivalent substitutions for some or all of the technical features therein. These modifications or substitutions do not depart the essence of the corresponding technical solution from the scope of the technical solutions of the embodiments of the present disclosure.

What is claimed is:

1. An inflatable structure, comprising a first layer and a second layer, wherein a plurality of baffles are arranged between the first layer and the second layer, and a first tubular cavity is formed between the first layer and the second layer by two adjacent baffles, wherein a composite material is arranged within the first tubular cavity, and
the composite material comprises a plurality of filling materials which are sequentially stacked from top to bottom, wherein a reflective layer is arranged between two adjacent filling materials, an upper end of the composite material is connected to the first layer, and a lower end of the composite material is connected to the second layer.

2. The inflatable structure according to claim 1, wherein a material of the first layer, the second layer, and the baffles comprises one of a textile with a PVC coating, a textile with a TPU coating, a PVC film, and a TPU film.

3. The inflatable structure according to claim 1, wherein each filling material is a hollow fiber cotton.

4. The inflatable structure according to claim 1, wherein the reflective layer is a PET film coated with aluminum or an aluminum foil; and each filling material is adhered to the reflective layer.

5. The inflatable structure according to claim 1, wherein an edge of the first layer is connected to an edge of the second layer; a connecting cavity in communication with the first tubular cavity is formed on both ends in a length direction of the first tubular cavity; and a second tubular cavity is formed on both sides in the length direction of the first tubular cavity.

6. The inflatable structure according to claim 5, wherein the second tubular cavity is provided therein with the composite material.

7. An inflatable product, comprising the inflatable structure according to claim 1.

8. The inflatable product according to claim 7, further comprising an air nozzle, wherein the air nozzle is arranged on the first layer or the second layer, and the air nozzle is communicated with the connecting cavity.

9. A method for manufacturing an inflatable product, comprising following steps:
S1, welding upper and lower ends of a plurality of baffles onto a first layer and a second layer separately, so that a plurality of first tubular cavities are formed;
S2, inserting a composite material into the first tubular cavities and ensuring that a reflective layer is horizontal;
S3, melting a coating on an inner wall of each first tubular cavity by applying heat externally to the first layer, and welding an upper end of the composite material to the first layer; and melting the coating on the inner wall of each first tubular cavity by applying heat externally to the second layer, and welding a lower end of the composite material to the second layer; and
S4, welding an edge of the first layer and an edge of the second layer together.

10. The method for manufacturing the inflatable product according to claim 9, wherein before step S1, the method further comprises step S0, adhering a filling material to the reflective layer to form the composite material.

11. The inflatable product according to claim 7, wherein a material of the first layer, the second layer, and the baffles comprises one of a textile with a PVC coating, a textile with a TPU coating, a PVC film, and a TPU film.

12. The inflatable product according to claim 7, wherein each filling material is a hollow fiber cotton.

13. The inflatable product according to claim 7, wherein the reflective layer is a PET film coated with aluminum or an aluminum foil; and each filling material is adhered to the reflective layer.

14. The inflatable product according to claim 7, wherein an edge of the first layer is connected to an edge of the second layer; a connecting cavity in communication with the first tubular cavity is formed on both ends in a length direction of the first tubular cavity; and a second tubular cavity is formed on both sides in the length direction of the first tubular cavity.

15. The inflatable product according to claim 14, wherein the second tubular cavity is provided therein with the composite material.
